(19) United States
(12) Patent Application Publication
(10) Pub. No.: US 2026/0304569 A1
(43) Pub. Date: Oct. 1, 2026

(54) DOOR COOLING SYSTEM IN MICROWAVE OVEN

(71) Applicant: WHIRLPOOL CORPORATION, BENTON HARBOR, MI (US)

(72) Inventors: Xiangxu Liu, I, Shenzhen (CN); Xuncai Zhang, Shenzhen (CN); Kunfeng Zhang, Shenzhen (CN); Jintao Huang, Foshan City (CN)

(73) Assignee: WHIRLPOOL CORPORATION, BENTON HARBOR, MI (US)

(21) Appl. No.: 19/477,900

(22) PCT Filed: Apr. 24, 2023
(86) PCT No.: PCT/CN2023/090326

§ 371 Date: Oct. 23, 2025

(51) Int. Cl. H05B 6/64; F24C 15/04

(52) U.S. Cl. CPC H05B 6/642; F24C 15/04; H05B 6/6414

(57) ABSTRACT

A cooking appliance includes a door operably coupled to a body and having a ventilation system. The door having an opened position allowing access to a cooking cavity and a closed position sealing the cooking cavity. The body includes an inlet, a body outlet, and a door outlet. The door includes a door inlet, a pair of frame edge outlets and defines a channel therebetween. The door inlet and the door outlet of the body are in fluid communication when the door is in the closed position, allowing air to flow from the body to the door. The body includes a fan disposed over the inlet configured air into an internal cavity of the body. The fan directs air directs air along a door cooling path from the inlet, through the internal cavity, to the door outlet, and through a door cooling path defined in the channel of the door.

### BACKGROUND OF THE DISCLOSURE

The present disclosure generally relates to a cooling system in an appliance, and more specifically, to a door cooling system in a countertop appliance.

### SUMMARY OF THE DISCLOSURE

According to one aspect of the present disclosure, a countertop cooking appliance includes a body having a plurality of panels including a front panel defining a door outlet, a bottom panel defining an inlet, a top panel defining a body outlet, and a side panel. An internal housing is disposed in the body and defining a cooking cavity, where an electronics cavity is defined between the internal housing and the body. A cooling fan is disposed in the electronics cavity proximate to the inlet where the cooling fan is configured to direct air along a door airflow path from the inlet through the door outlet and along a body airflow path from the inlet and through the body outlet. A door is operably coupled to the body where the door is operable between a closed position and an opened position. The door includes a frame defining a first frame outlet on an upper portion of a first frame edge and a second frame outlet on an upper portion of a second frame edge. An inner panel is coupled to the frame, where the inner panel defines a door inlet on a lower portion thereof. An outer panel is coupled to the frame, where the frame, the outer panel, and the inner panel defines a channel through which air flows forming a door air cooling path for directing the air from the door inlet to the first and second frame outlets. The door inlet is in fluid communication with the door outlet when the door is in the closed position.

According to another aspect of the present disclosure, a cooking appliance includes a body defining an internal cavity where the body has a front panel defining a door outlet. A cooking fan is disposed within the internal cavity. A door is operably coupled to the body. The door includes a frame defining a first outlet on an upper portion of a first frame edge and a second outlet on an upper portion of a second frame edge. An inner panel is coupled to the frame, where the inner panel defines a door inlet on a lower portion thereof to receive air directed through the door outlet by the cooling fan. An outer panel is coupled to the frame, where the frame, the outer panel, and the inner panel define a channel through which the air is configured to flow to define a door air cooling path from the door inlet and to the first and second outlets.

According to yet another aspect of the present disclosure, an appliance door includes a frame defining a first air outlet and a second air outlet on opposing side edges of the frame. A first panel is coupled to the frame and configured to abut an appliance body when said appliance door is in a closed position. A lower portion of the first panel defines an air inlet for receiving air. A second panel is coupled to the frame, where the frame, the first panel, and the second panel define a channel through which the air is configured to flow to define a door air cooling path from the air inlet to the first and second air outlets.

These and other features, advantages, and objects of the present disclosure will be further understood and appreciated by those skilled in the art by reference to the following specification, claims, and appended drawings.

### BRIEF DESCRIPTION OF THE DRAWINGS

In the drawings:

FIG. 1 is a side perspective view of a cooking appliance, according to the present disclosure;

FIG. 2 is a bottom perspective view of a cooking appliance with a bottom panel defining an inlet, according to the present disclosure;

FIG. 3 is a side perspective view of a cooking appliance with a door removed to illustrate airflow paths, according to the present disclosure;

FIG. 4 is a side perspective view of a cooking appliance with a top panel, a pair of side panels, and a door removed to illustrate airflow paths, according to the present disclosure;

FIG. 5 is a rear perspective view of a cooking appliance with a top panel, a pair of side panels, and a back panel removed to illustrate airflow paths, according to the present disclosure;

FIG. 6 is a partial enlarge side perspective view of a cooking appliance with an internal cavity defining a cavity outlet, according to the present disclosure;

FIG. 7 is a bottom perspective view of a cooking appliance with a cooling fan disposed in a electronics cavity and with a bottom panel and a side panel removed to illustrate airflow paths, according to the present disclosure;

FIG. 8 is a side perspective view of a cooking appliance with a door in a closed position and the door in phantom in an opened position, according to the present disclosure;

FIG. 9 is a side perspective view of a door for a cooking appliance, according to the present disclosure;

FIG. 10 is an exploded side perspective view of a door for a cooking appliance, according to the present disclosure;

FIG. 11 is a cross-sectional view of the door for the cooking appliance of FIG. 9, taken at XI, according to the present disclosure;

FIG. 12 is a side perspective view of a frame for an appliance door, according to the present disclosure;

FIG. 13 is an exploded side perspective view of an inner panel assembly for an appliance door, according to the present disclosure; and

FIG. 14 is a cross-sectional view of a cooking appliance, illustrating an airflow path, according to the present disclosure.

The components in the figures are not necessarily to scale, emphasis instead being placed upon illustrating the principles described herein.

### DETAILED DESCRIPTION

The present illustrated embodiments reside primarily in combinations of method steps and apparatus components related to a cooking appliance. Accordingly, the apparatus components and method steps have been represented, where appropriate, by conventional symbols in the drawings, showing only those specific details that are pertinent to understanding the embodiments of the present disclosure so as not to obscure the disclosure with details that will be readily apparent to those of ordinary skill in the art having the benefit of the description here. Further, like numerals in the description and drawings represent like elements.

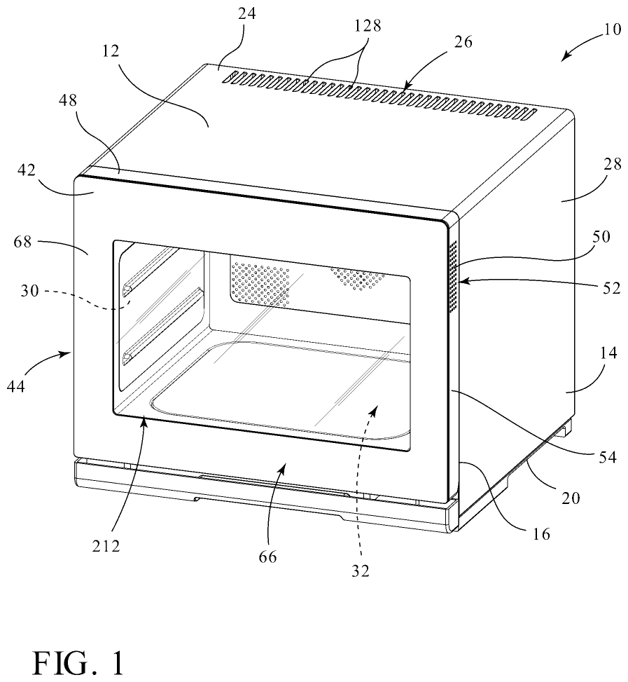

For purposes of description herein, the terms “upper,” “lower,” “right,” “left,” “rear,” “front,” “vertical,” “horizontal,” and derivatives thereof shall relate to the disclosure as oriented in FIG. 1. Unless stated otherwise, the term “front” shall refer to the surface of the element closer to an intended viewer, and the term “rear” shall refer to the surface of the element further from the intended viewer. However, it is to be understood that the disclosure may assume various alternative orientations, except where expressly specified to the contrary. It is also to be understood that the specific devices and processes illustrated in the attached drawings, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

The terms “including,” “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises a” does not, without more constraints, preclude the existence of additional identical elements in the process, method, article, or apparatus that comprises the element.

Referring to FIGS. 1-13, reference numeral 10 generally designates a cooking appliance. The cooking appliance 10 includes a body 12, also referred to as an appliance body 12, having a plurality of panels 14 including a front panel 16 defining a door outlet 18, a bottom panel 20 defining an inlet 22, a top panel 24 defining a body outlet 26, and a side panel 28. An internal housing 30 is disposed in the body 12 and defines a cooking cavity 32. An electronics cavity 34 is defined between the internal housing 30 and the body 12. A cooling fan 36 is disposed in the electronics cavity 34 proximate to the inlet 22. The cooling fan 36 is configured to direct air along a door airflow path 38 from the inlet 22 and through the door outlet 18. The cooling fan 36 is also configured to direct air along a body airflow path 40 from the inlet 22 and through the body outlet 26.

A door 42, also referred to as an appliance door 42, is operably coupled to the body 12 and is operable between a closed position 44 and an opened position 46. The door 42 includes a frame 48 defining a first frame outlet 50 on an upper portion 52 of a first frame edge 54 and a second frame outlet 56 on an upper portion 58 of a second frame edge 60, an inner panel 62 coupled to the frame 48 where the inner panel 62 defines a door inlet 64 on a lower portion 66 thereof, and an outer panel 68 coupled to the frame 48. The frame 48, the outer panel 68, and the inner panel 62 define a channel 70 through which air is configured to flow forming a door air cooling path 72 for directing the air from the door inlet 64 to the first and second frame outlets 50, 56. The door inlet 64 is in fluid communication with the door outlet 18 when the door 42 is in the closed position 44.

The cooking appliance 10 is illustrated as a microwave oven 10. The microwave oven 10 has microwave components 90, also referred to as microwave electronics 90, which may include a magnetron, a controller 92 to control the microwave oven 10, and a control panel 94 disposed in the door 42. The control panel 94 is configured as a touch capacitive panel but can be configured with physical buttons, a touch screen, or any other control method. The microwave components 90 may include any component commonly included in a microwave oven and is not limited to the listed components or components discussed herein.

The controller 92 generally includes a processor, a memory, and other control circuitry. Instructions or routines are stored in the memory and executable by the processor. The controller 92 disclosed herein may include various types of control circuitry, digital or analog, and may include a processor, a microcontroller, an application specific integrated circuit (ASIC), or other control circuitry configured to perform various inputs or output, control, analysis, or other functions described herein. The memory described herein may be implemented in a variety of volatile and nonvolatile memory formats. Routines include operating instructions to enable the various processes and methods described herein.

The microwave oven 10 includes a ventilation system 100 to cool the appliance 10, including various components and parts of the appliance 10. The ventilation system 100 may be configured to cool the body 12, the door 42, the cooking cavity 32, the microwave components 90, other components included in the appliance 10, and/or combinations thereof. The cooking appliance 10 is not limited to a microwave oven. The ventilation system 100 may be used in other appliances and applications including other ovens, such as a convection oven, a steam oven, and/or a conventional oven. The ventilation system 100 is also not limited to countertop cooking and may be used in appliances 10 that are configured as a floor placement appliance, a cabinet mounting appliance, a wall mounting appliance, and/or a combination with other appliances, such as vent hoods.

Referring to FIGS. 1-8, the cooking appliance 10 includes the body 12, which has a plurality of panels 14 that defines an internal cavity 108. The plurality of panels 14 of the body 12 include the front panel 16, the bottom panel 20, the top panel 24, the first side panel 28, and a second side panel 112. The internal housing 30 is disposed within the internal cavity 108 and is coupled to the body 12. The internal housing 30 has a plurality of walls 110 that defines the cooking cavity 32. The plurality of walls 110 includes a back wall 114, a top wall 116, a bottom wall 118, and a pair of side walls 120a, 120b. The internal housing 30 and the body 12 define the electronics cavity 34 therebetween. The internal cavity 108 includes at least the cooking cavity 32 and electronics cavity 34. Generally, there is space between each panel 14 of the body 12 and each wall 110 of the internal housing 30, allowing airflow as described herein.

The front panel 16 of the body defines an access opening or access aperture 122 for access to the cooking cavity 32. The top wall 116, the bottom wall 118, and the pair of side walls 120a, 120b collectively define a corresponding access aperture 124 to the access aperture 122 of the front panel 16. The access apertures 122, 124 may be of the same size and align with one another. The back wall 114 of internal housing 30 is opposite to the apertures 122, 124.

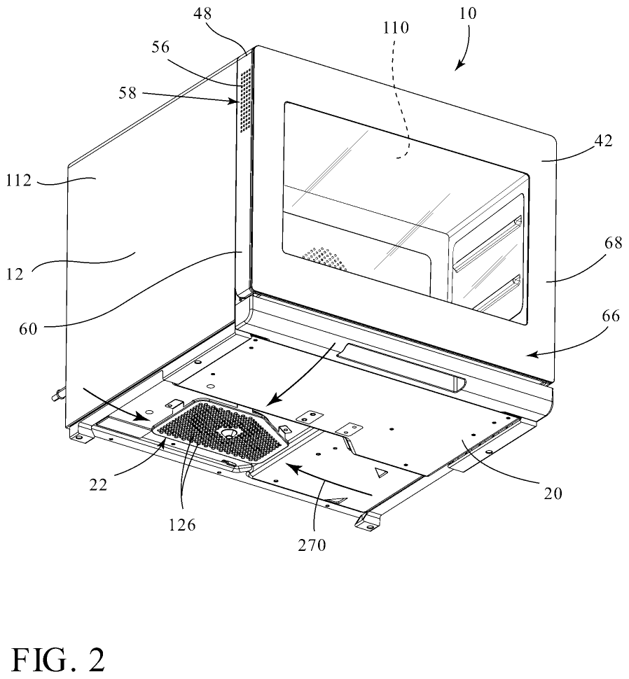

Referring still to FIG. 2, the bottom panel 20 of the body 12 defines the inlet 22, also referred to as the body inlet 22. The internal cavity 108 is in fluid communication with a space outside the appliance 10 through the inlet 22, allowing air to enter the internal cavity 108. The inlet 22 is not limited to the bottom panel 20 and may be defined on one or more of the plurality of panels 14 of the body 12. The inlet 22 may be defined by a plurality of apertures 126 but is not limited to such and may be a single aperture. The plurality of apertures 126 may be circular apertures, as shown, rectangular apertures, square apertures, or a combination of shapes and/or sizes. Moreover, the apertures 126 may be arranged in a single grouping as illustrated or multiple groupings about the body 12 without departing from the teachings herein.

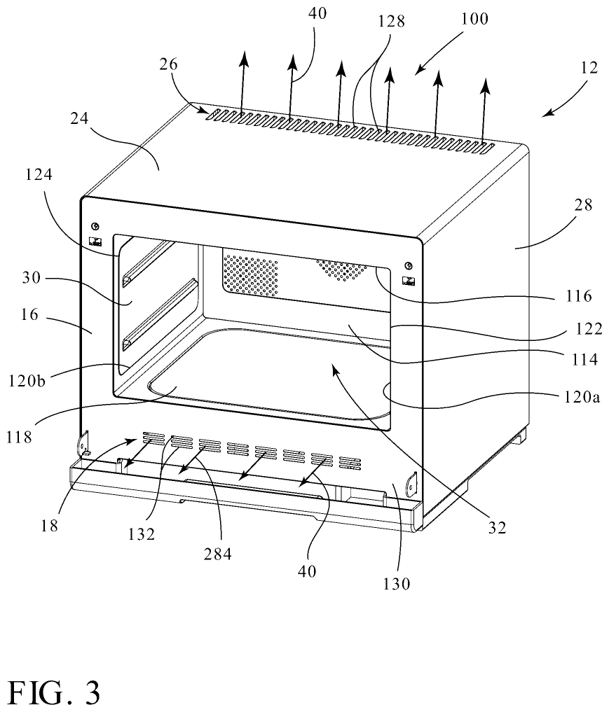

Referring again to FIGS. 1 and 3, the top panel 24 of the body 12 defines the body outlet 26. The internal cavity 108 is in fluid communication with the space outside the appliance 10 via the body outlet 26, allowing the air to be expelled from the internal cavity 108. The body outlet 26 is also in fluid communication with the inlet 22 via the internal cavity 108, allowing the air to travel through the internal cavity 108. The body outlet 26 is not limited to the top panel 24 and may be defined on one or more of the plurality of panels 14 of the body 12. The outlet 26 is illustrated having a generally rectangular shape extending across a width of the body 12 but is not limited to such configuration. The outlet 26 may be defined by a plurality of apertures 128, such as slots as illustrated in FIGS. 1 and 3, which are arranged in a linear pattern along a rear edge of the top panel 24. The plurality of apertures 128 are not limited to slots and may be circular apertures, rectangular apertures, square apertures, or a combination of shapes and/or sizes. The outlet 26 is not limited to the plurality of apertures 128 and may be a single aperture. Moreover, the apertures 128 may be arranged in a single, continuous grouping as illustrated, or multiple groupings about the body 12 without departing from the teachings herein.

Referring still to FIG. 3, the front panel 16 defines the door outlet 18, also referred to as the door cooling outlet 18 or the cooling outlet 18. The internal cavity 108 is in selective fluid communication with the door 42 via the door outlet 18, allowing air to flow from the internal cavity 108 and into the door 42, as discussed in more detail herein. The door outlet 18 may be disposed on a lower portion 130 of the front panel 16 below the cooking cavity 32. The door outlet 18 may be defined across the width of the body 12. The door outlet 18 may be defined by a plurality of apertures 132, as illustrated in FIG. 3, but may be a single aperture. The plurality of apertures 132 may be circular apertures, rectangular apertures, square apertures, other shaped apertures, or a combination of shapes and/or sizes. As illustrated, the plurality of apertures 132 are arranged in a linear pattern along the width of the front panel 16.

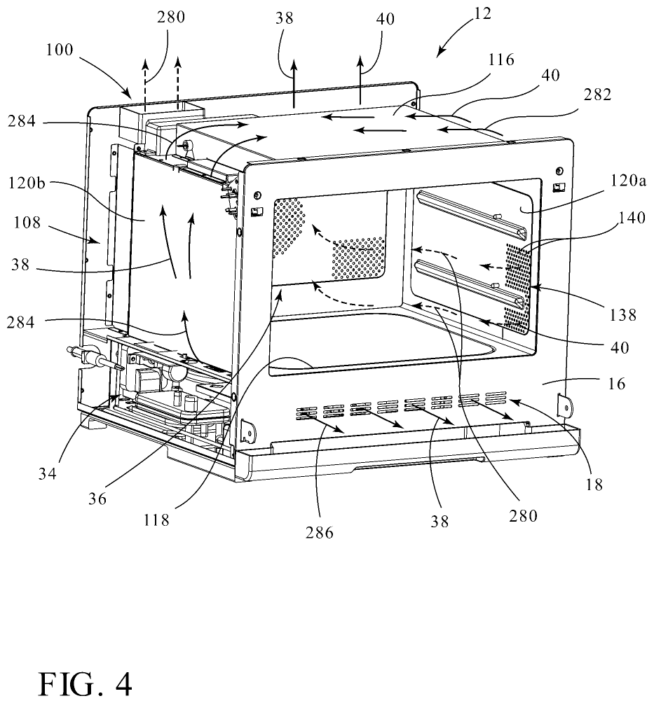

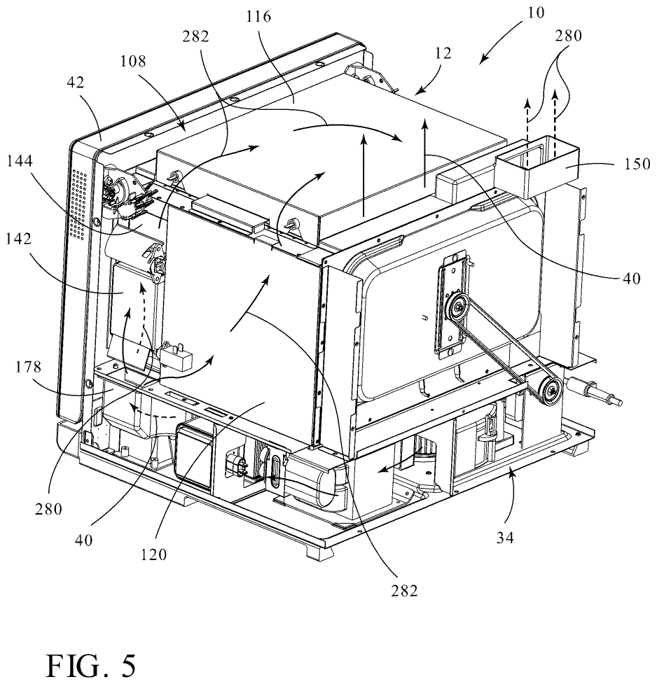

Referring to FIGS. 4 and 5, the side wall 120a of the internal housing 30 generally defines a cooking cavity inlet 138. The cooking cavity inlet 138 is not limited to the side wall 120a and may be defined on any of the plurality of walls 110 of the internal housing 30. The cooking cavity 32 is in fluid communication with the space outside the appliance 10 through the cooking cavity inlet 138 and the body inlet 22, allowing air to enter the internal cavity 108 and then the cooking cavity 32. The electronics cavity 34 is in direct fluid communication with the space outside the appliance 10 through the inlet 22. The air may travel through the electronics cavity 34 before entering the cooking cavity 32. The cooking cavity inlet 138 may be defined by a plurality of apertures 140 creating a vent or a grate. The plurality of apertures 140 may be circle apertures, but may be other shaped apertures 140 such as rectangles, squares, and/or a combination of shapes. The cooking cavity inlet 138 may also be defined by a single aperture. The cooking cavity inlet 138 may have an air guide 142, also referred to as an air tube 142, that directs and guides air into the cooking cavity 32. The air guide 142 may be coupled to an outside surface 144 of the side wall 120a that defines the cooking cavity inlet 138.

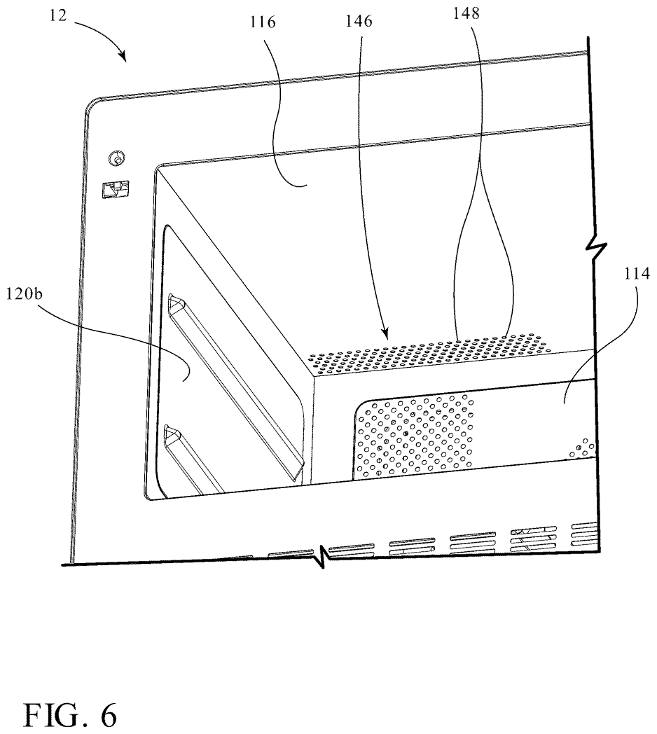

Referring to FIGS. 5 and 6, the top wall 116 of the internal housing 30 may define a cooking cavity outlet 146. The cooking cavity outlet 146 is not limited to the top wall 116 and may be defined on any one or more of the plurality of walls 110 of the internal housing 30. The cooking cavity 32 is in fluid communication with the space outside the appliance 10 through the cooking cavity outlet 146 and the body inlet 22, allowing air to exit the cooking cavity 32 and ultimately the appliance 10. The cooking cavity outlet 146 is in fluid communication with the cooking cavity inlet 138, allowing for air to travel through the cooking cavity 32. As illustrated, the cooking cavity outlet 146 is defined in the top wall 116 proximate to the side wall 120b, which opposes the side wall 120a that defines the cooking cavity inlet 138. Accordingly, the air is configured to flow across the cooking cavity 32.

The cooking cavity outlet 146 may be defined by a plurality of apertures 148 creating a vent or grate. The plurality of apertures 148 may be circle apertures, but may be other shaped apertures such as rectangles, squares, and/or a combination of shapes. The cooking cavity outlet 146 may also be defined by a single aperture. An air guide 150 may be aligned with the cooking cavity outlet 148 to receive the air from the cooking cavity 38 and direct the air through the body outlet 26. The air guide 150 may prevent air from feeding back into the electronics cavity 34 after being expelled from the cooking cavity 38.

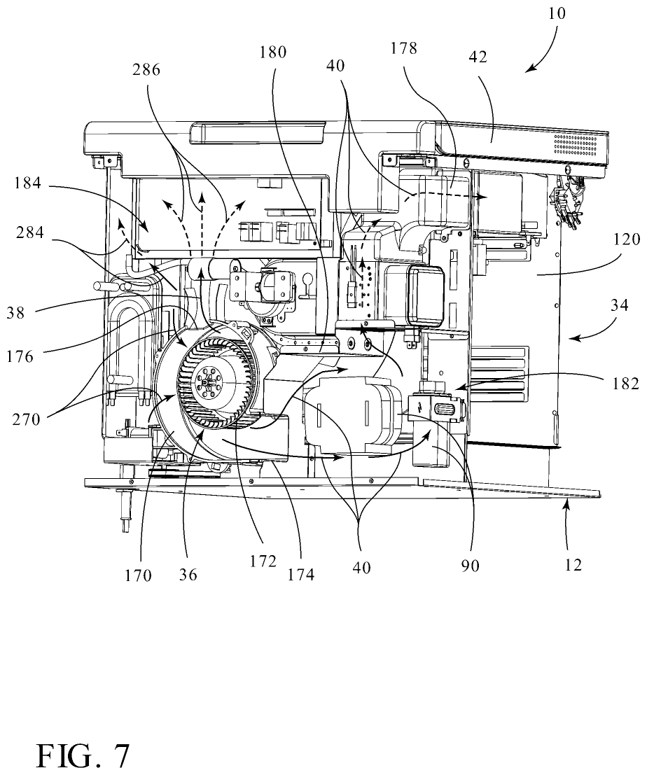

Referring to FIG. 7, the electronics cavity 34 generally contains the microwave component 90 and the cooling fan 36. The electronics cavity 34 is disposed below the internal housing 30, but may be in other locations without departing from the teachings herein. The cooling fan 36 is generally positioned in the electronics cavity 34 and disposed proximate to the inlet 22 defined on the bottom panel 20. In certain aspects, the cooling fan 36 may be disposed over the inlet 22. The cooling fan 36 is configured to draw air through the inlet 22 and push or direct the air through the internal cavity 108 along multiple airflow paths. The air directed through the internal cavity 108 is used to cool various components of the appliance 10, which may include the body 12, the door 42, and/or the appliance components 90.

The cooling fan 36 may include a fan body 170, a fan blade 172, and a motor to drive the fan blade 172. The fan body 170 may be configured to direct or push air in one or more directions. In the illustrated configuration, the fan body 170 includes a first outlet 174 to direct air in a first direction and a second outlet 176 to direct air in a second direction to generate multiple airflow paths through the appliance 10. Other configurations of the cooling fan 36 for generating multiple airflow paths are contemplated without departing from the teaching herein.

The electronics cavity 34 may include air guides, directors, or tubes to manage the flow of air, as discussed further herein. The air guides, directors, or tubes may be static and passively direct air within the electronics cavity 34, the cooking cavity 32, and/or the internal cavity 108. The air guides, directors or tubes may also include actuators to open or close, move, or reconfigure the air guides, directors or tubes, which allows for active control of directing air throughout the electronics cavity 34, the cooking cavity 32, and/or the internal cavity 108. The air guides, directors or tubes allow for air to be directed to portions of the appliance 10 that have more heat or are hotter, providing more cooling to these areas compared to other portions of the appliance 10.

According to various aspects, the electronics cavity 34 includes an air tube 178 to direct the airflow from one portion of the electronics cavity 34 to another portion. The air tube 178 is configured to direct air proximate to the cooking cavity inlet 138 and proximate the side panel 28 of the body 12. The electronics cavity 34 may also have an internal barrier 180 to divide the electronics cavity 34 into a first zone 182 and a second zone 184. The internal barrier 180 may assist in directing the airflow through the electronics cavity 34 by separating airflow paths into the first zone 182 or the second zone 184. The appliance 10 is not limited to the illustrated configuration of air guides, directors, or tubes to manage the flow of air.

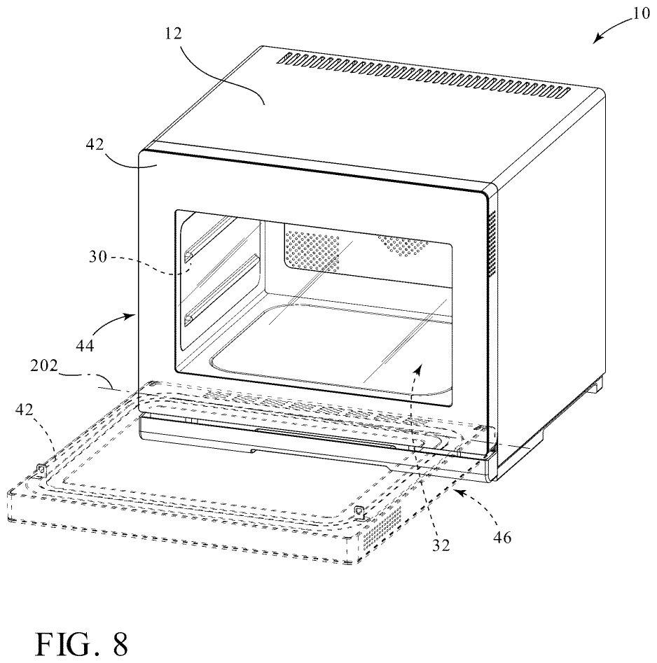

Referring to FIGS. 8-14, the door 42 is operably coupled to the body 12 to allow for selective access to the cooking cavity 32. The door 42 is configured to move between the opened position 46 (as shown in phantom in FIG. 8), also referred to as the first position 46, and the closed position 44, also referred to as the second position 44. The door 42 seals and prevents access to the cooking cavity 32 when in the closed position 44 and allows access to the cooking cavity 32 when in the opened position 46. The inner panel 62 of the door 42 abuts the body 12 of the appliance when in the closed position 44.

The door 42 may be coupled to the body 12 using a hinge assembly 200. In the illustrated configuration, the door 42 rotate along a horizontal axis 202 located along the lower portion 130 of the front panel 16. The door 42 is not limited to the hinge assembly 200 or hinge assemblies generally and may have a vertical hinge assembly allowing rotation along a vertical axis or be configured as a drawer pull assembly or other assembly allowing for the door 42 to move between the opened position 46 and the closed position 44. The horizonal hinge assembly 200 may also be located on an upper portion of the front panel 16 without departing from the teachings herein.

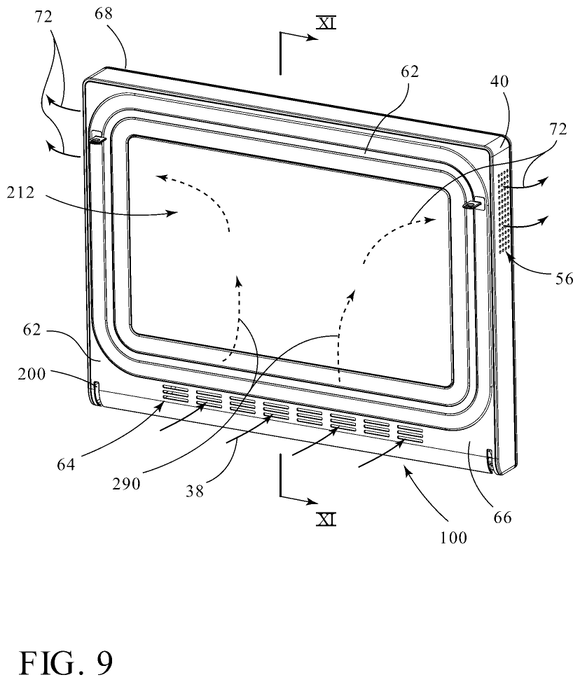

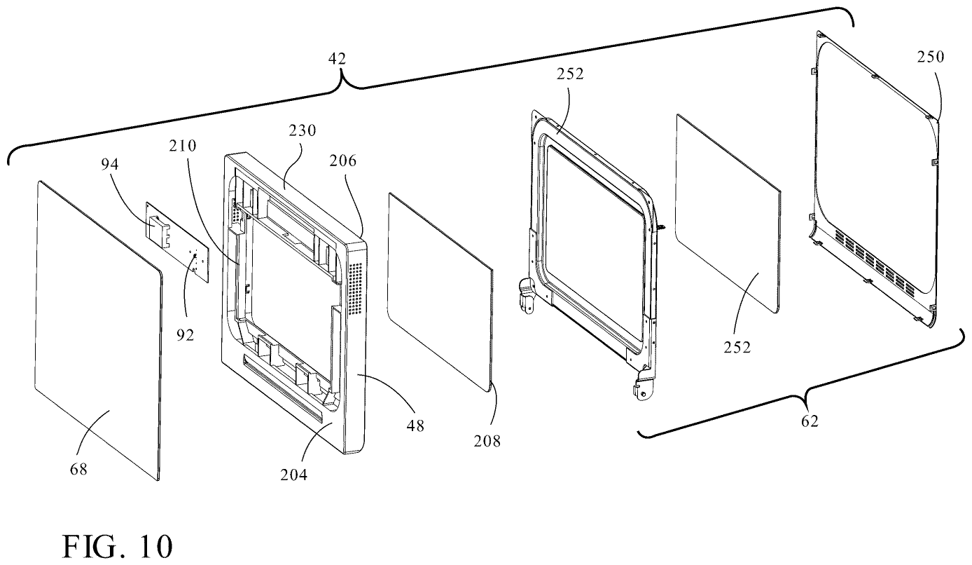

Referring still to FIGS. 9 and 10, the door 42 includes the frame 48, the inner panel 62, and the outer panel 68. The door 42 may also include the controller 92 and the control panel 94 coupled to the frame 48 and disposed behind the outer panel 68. The outer panel 68 is coupled to an outer frame surface 204 of the frame 48 using a fastening device. The outer panel 68 is illustrated as a single continuous panel but is not limited as such and may include multiple components.

The inner panel 62, also referred to as the inner panel assembly 62, is coupled to an inner frame surface 206 of the frame 48 also using a fastening device. The door 42 may also include an internal panel 208 disposed between the inner panel 62 and the outer panel 68. The internal panel 208 may be coupled to an internal surface 210 of the frame 48 using a fastening device. The internal panel 208 may alternatively be coupled to the inner panel 62 or the outer panel 68. The fastening devices for each of the panels 62, 68, 208 can include adhesives or mechanical fasteners, such as screws or clips.

The door 42 generally defines a viewport 212 that creates a sight line through the door 42 to the cooking cavity 32. The viewport 212 is defined by the inner panel 62 and the outer panel 68 and may further be defined by the internal panel 208, if included in the door 42. The inner panel 62, the outer panel 68, and the internal panel 208 may be partially or fully constructed of a transparent or partially transparent material, such as glass or glass-ceramic, to define the viewport 212. The viewport 212 is generally located above the door inlet 64 when the door 42 is in the closed position 44.

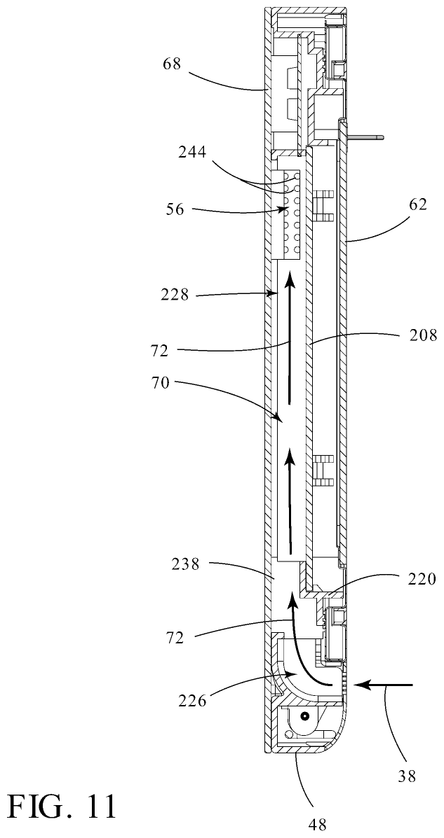

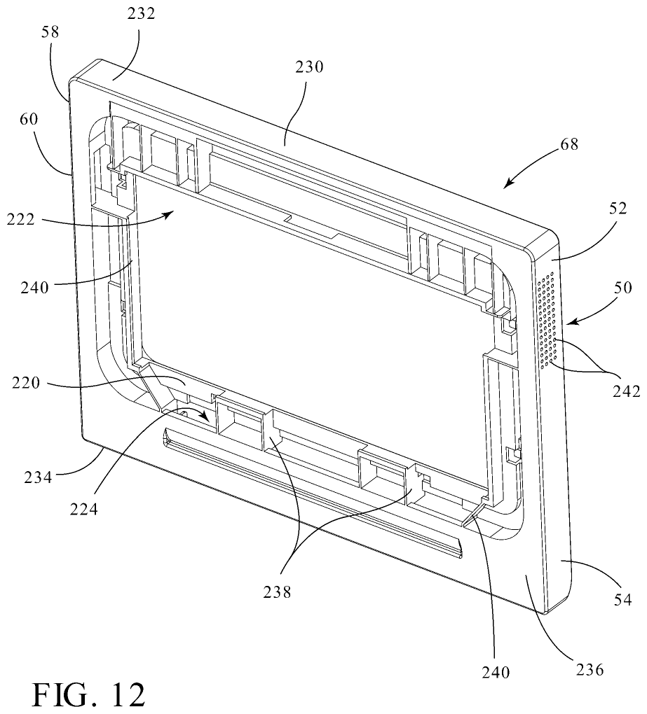

Referring to FIGS. 11 and 12, the channel 70, also referred to as the door cooling channel 70, is defined by the frame 48, the inner panel 62, and the outer panel 68. The door cooling channel 70 may be further defined by the internal panel 208. The channel 70 is configured to allow air to flow therein, thus allowing the door 42 to be cooled using the flowing air.

The frame 48 generally includes a crossmember 220 defining an upper portion 222 of the frame 48 and a lower portion 224 of the frame 48. The channel 70 has at least one inlet channel 226 defined in the lower portion 224 of the frame 48, and an outlet channel 228 defined in the upper portion 222 of the frame 48. The inlet channel 226 and the outlet channel 228 are in fluid communication and allow air to travel therebetween. In this way, the air flows through the inlet channel 226 and then into the outlet channel 228 before being expelled or exhausted from the door 42.

The frame 48 includes a plurality of walls 230 that may include the first frame edge 54, also referred to as the first side frame wall 54, the second frame edge 60, also referred to as the second side frame wall 60, a top frame wall 232, a bottom frame wall 234, and an outer frame wall 236. The frame 48 may include support structures and air guides, such as the crossmember 220. The crossmember 220 may be coupled to the outer frame wall 236 or to the first and second side frame walls 54, 60.

The frame 48 may include one or more air dividers 238 coupled to the outer frame wall 236 and the crossmember 220. The air dividers 238 may be configured support the crossmember 220 and direct air flowing between the inlet channel 226 and the outlet channel 228. The frame 48, as illustrated, includes a pair of air dividers 238, which generally generate three airflow paths in the door 42.

The frame 48 may also include a pair of air guides 240 coupled to the outer frame wall 236, the crossmember 220, and to the first and second side frame walls 54, 60. The air guides 240 are configured to guide air flowing in the channel 70 to the first frame outlet 50 and the second frame outlet 56, discussed in further detail below. The air guides 240 may also be configured to guide air from the inlet channel 226 to the outlet channel 228. The frame 48 in not limited to the pair of air dividers 238 or the pair of air guides 240, and may include other air guides or directors to direct air flowing through the channel 70 from the door inlet 64 to the first and second frame outlets 50, 56. The air dividers 238, the air guides 240, and other air guides or directors may be configured to distribute air throughout the channel 70 to cool the door 42 and minimize temperature variation throughout the door 42 and on the outer panel 68. Moreover, the air dividers 238, the air guides 240, and other air guides or directors may be configured to evenly distribute the airflow from the door inlet 64 throughout the channel 70, if rate of airflow is different in a location of the channel 70 based on the positioning of the cooling fan 36 or other components that affect the airflow in the body 12 of the appliance 10 to the door inlet 64.

Referring still to FIGS. 11 and 12, the frame 48 defines the first frame outlet 50, also referred to as the first air outlet 50, and the second frame outlet 56, also referred to as the second air outlet 56, which can collectively be referred to herein as the pair of frame outlets 50, 56 or the frame outlets 50, 56. The channel 70 is in fluid communication with the space outside of the appliance 10 through the frame outlets 50, 56, allowing for air to exit the channel 70 and, consequently, the door 42. The first frame outlet 50 is defined on the upper portion 52 of the first frame edge 54 and may have a single aperture or a plurality of apertures 242 defining the frame outlet 50. Similarly, the second frame outlet 56 is defined on the upper portion 58 of the second frame edge 60 and may also have a single aperture or a plurality of apertures 244 defining the frame outlet 56. The first frame outlet 50 and the second frame outlet 56 are defined on opposing sides of the frame 48. The plurality of apertures 242, 244 may be circle apertures, as shown, but may be other shaped apertures such as rectangles, squares, and/or other shapes or combination of shapes.

Moreover, the frame outlets 50, 56 are generally horizontally aligned with one another, allowing for even airflow out of the door 42. However, it is contemplated that one frame outlet 56 may be at a different height than the other frame outlet 50. For example, the air may be directed into the door 42 along the width of the door 42, however, the rate of airflow may be different based on the location of the cooling fan 36. The different locations of the frame apertures 50, 56 may be advantageous for quickly venting the air through the door 42. The frame outlets 50, 56 are configured to expel the air that flows through the channel 70, which has removed heat from the door. The frame outlets 50, 56 may be configured to expel air away from the body inlet 22 or generally away from the appliance 10 to reduce or prevent recirculation of the warmed or heated air exiting the door 42.

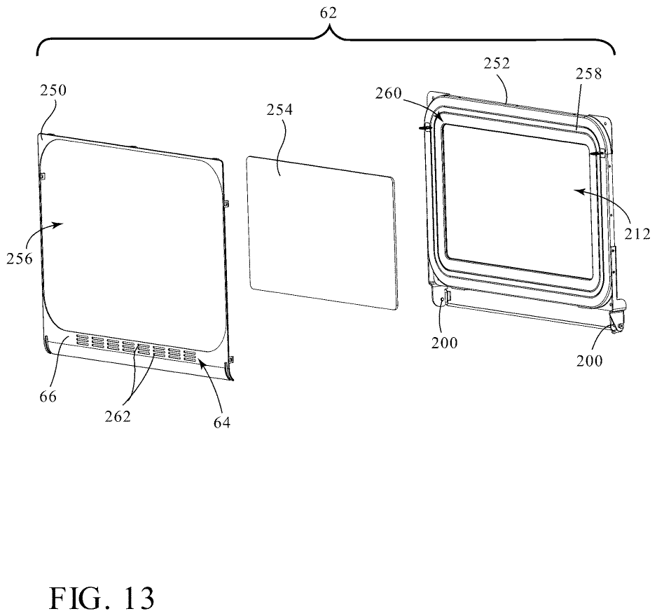

Referring to FIG. 13, the inner panel assembly 62 may include a frame member 250, a support member 252, and a panel member 254. The inner panel 62 is not limited to a multi-part assembly and may be a single continuous panel. The frame member 250 may define an aperture 256 that receives a raised portion 258 of the support member 252. The support member 252 may define a central opening 260 to receive the panel member 254. The aperture 260 may partially define the viewport 212 when the panel member 254 is constructed of a transparent or semi-transparent material. The panel member 254 may be a glass panel that at least partially defines the viewport 212. The support member 252 may be configured to include portions of the hinge assembly 200 to couple the door 42 to the body 12.

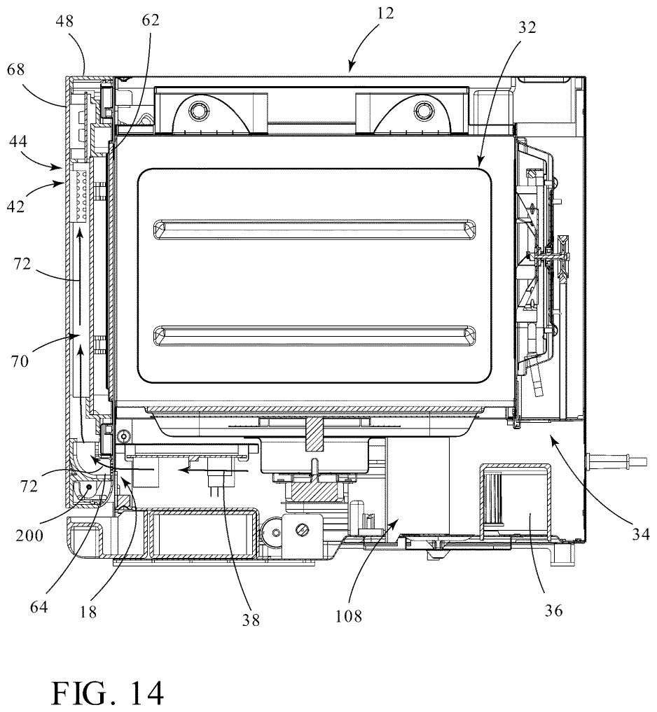

Referring to FIGS. 13 and 14, the door inlet 64, also referred to as the air inlet 64, is defined by the lower portion 66 of the inner panel 62. In the illustrated example, the door inlet 64 is defined in the frame member 250 of the inner panel 62. The door inlet 64 is in selective fluid communication with the door outlet 18 defined on the body 12. When the door 42 is in the closed position 44, the door inlet 64 is disposed adjacent to and in fluid communication with the door outlet 18, allowing air to enter the channel 70. Accordingly, the door inlet 64 is configured to receive air from the body 12.

When the door is in the opened position 46, the door inlet 64 is spaced from and generally not in direct fluid communication with the door outlet 18. The door inlet 64 may be defined by a single aperture or a plurality of apertures 262. The plurality of apertures 262 may be rounded rectangle apertures, as shown, but may be other shaped apertures such as circles, rectangles, squares, and/or other shapes or combination of shapes. The plurality of apertures 262 may be configured to vary, distribute, or even the airflow through the channel 70 of the door 42. This may be advantageous to target airflow to particular portions of the door 42 that where more heat can be removed compared to other portions of the door 42.

The door inlet 64 generally corresponds with and is spaced along a similar width of the door 42 as the door outlet 18 is spaced along the width of the body 12. The plurality of apertures 262 defining the door inlet 64 may have similar shapes, sizes, and number of apertures as the plurality of apertures 132 defining the door outlet 18 to maximize airflow therebetween. The plurality of apertures 262 defining the door inlet 64 may be positioned such that each individual aperture of the door inlet 64 is aligned with an individual aperture of the plurality of apertures 132 defining the door outlet 18, when the door 42 is in the closed position 44.

Referring again to FIG. 7, the components of the appliance 10 are arranged to allow multiple airflow paths through the appliance 10. The ventilation system 100 of the microwave oven 10 includes the cooling fan 36, which is configured to draw air, represented by arrows 270, from outside of the body 12 into the internal cavity 108 via the body inlet 22. The appliance 10, when configured as a countertop or a floor appliance, includes feet that create space between a lower support surface (e.g., the floor, the countertop, etc.) and the body inlet 22 to allow the airflow into the appliance 10.

The cooling fan 36 pulls the air 270 into the appliance 10 and then pushes or moves the air along the door airflow path 38, represented by arrows 38, and the body airflow path 40, represented by arrows 40. Generally, the door airflow path 38 starts at the inlet 22 and extends through the internal cavity 108 of the body 12 to the door outlet 18. Accordingly, the air being directed along the door airflow path 38 is drawn through the inlet 22, flows through the internal cavity 109, and exits the internal cavity 108 through the door outlet 18. Similarly, the body airflow path 40 starts at the inlet 22 and extends through the internal cavity 108 of the body 12 to the body outlet 26. Accordingly, the air being directed along the body airflow path 40 is drawn through the inlet 22, flows through the internal cavity 108 of the body 12, and exits the internal cavity 108 through the body outlet 26.

Referring again to FIGS. 4, 5, and 7, in various examples, the air being directed along the body airflow path 40 is drawn through the inlet 22, flows through the cooling fan 36, and flows out of the first outlet 174 of the cooling fan 36. The body airflow path 40 extends through the first zone 182 of the electronics cavity 34 and is proximate to the microwave components 90. The air being directed along the body airflow path 40 enters and flows through the air tube 178 and exits proximate the air guide 142 to the cooking cavity inlet 138.

The body airflow path 40 has a first airflow branch 280 and a second airflow branch 282. The first airflow branch 280 of the body airflow path 40 extends from the air tube 178, through the cooking cavity inlet 138, through the cooking cavity 32, out of the cooking cavity 32 through the cooking cavity outlet 146, and out of the internal cavity 108 through the body outlet 26. The air guide 142 proximate the cooking cavity inlet 138 is configured to guide the air flowing along the first branch 280 of the airflow path 40 to the cooking cavity inlet 138. The air guide 150 proximate the cooking cavity outlet 146 is configured to direct the air flowing along the first branch 280 of the air flow path to the body outlet 26.

The second airflow branch 282 extends from the air tube 178, proximate the side wall 120b of the internal housing 30 and the side panel 28 of the body 12, proximate to the top wall 116 of the internal housing 30 and the top panel 24 of the body 12, and out of the internal cavity 108 through the body outlet 26. Stated differently, the air flowing along the first airflow branch 280 of the body airflow path 40 flows from the body inlet 22, through the internal cavity 108 proximate to the side panel 28, through the internal cavity 108 proximate the top panel 24, and out the body outlet 26. The air flowing along the second airflow branch 282 of the body airflow path 40 flows from the body inlet 22, through the internal cavity 108 proximate to the side panel 28, through the cooking cavity 32, and out the body outlet 26.

Referring to FIGS. 4 and 7, the ventilation system 100 is also configured to direct air along the door airflow path 38, where air is drawn through the inlet 22, flows through the cooling fan 36, and flows out the second outlet 176 of the cooling fan 36. The air flowing along the door airflow path 38 flows from the second outlet 176, through the internal cavity 108 of the body 12, through the second zone 184 of the electronics cavity 34, and through the door outlet 18.

The door airflow path 38 may have a first airflow branch 284 and a second airflow branch 286. The first airflow branch 284 extends from the inlet 22, through the cooling fan 36, through the second outlet 176, through the electronics cavity 34, proximate the second side panel 112 and the side wall 120b, and proximate the top panel 24 and top wall 116, and to the body outlet 26. The second airflow branch 286 extends from the inlet 22, through the cooling fan 36, through the second outlet 176, and to the door outlet 18. In this way, the air flowing along the first airflow branch 284 flows through the internal cavity 108 around the internal housing 30, while the air flowing along the second airflow branch 286 flows from the cooling fan 36 to the door 42. In this way, the second airflow branch 286 may not flow past many warmed components prior to exiting the body 12, resulting in cooler air entering the door 42. Accordingly, the ventilation system 100 is configured to define two airflow paths 38, 40 with four total airflow branches 280, 222, 284, 286 through the internal cavity 108.

Referring again to FIGS. 9, 11, and 14, the ventilation system 100 also generates the cooling airflow path 72 from the door airflow path 38. The channel 70 of the door 42 defines the door air cooling path 72 from the door inlet 64 to the first and second frame outlets 50, 56. The door air cooling path 72 is designated by arrow 72. When the door 42 is in the closed position 44, and the door inlet 64 is in fluid communication with the door outlet 18 defined on the body 12. Air flows along the door airflow path 38 through the door outlet 18 and into the door inlet 64. The door airflow path 38 transitions into the door air cooling path 72 as air flows from the door outlet 18 to the door inlet 64. The door air cooling path 72 extends from the door inlet 64, through the inlet channel 226, through the outlet channel 228, and to the first and second frame outlets 50, 56.

In examples where the door 42 has the internal panel 208 disposed between the inner panel 62 and the outer panel 68, the air being directed along the door air cooling path 72 is configured to flow between the internal panel 208 and the outer panel 68. The air flowing between the internal panel 208 and the outer panel 68 may provide more cooling to the outer panel 68 of the door 42 and reduce temperatures on the outer panel 68.

The pair of air guides 240 may direct air flowing along the door air cooling path 72 from the door inlet 64, through the channel 70, and to the first and second frame outlets 50, 56. The door air cooling path 72 may be divided by the air dividers 238 into a plurality of airflow paths 290 being directed through the channel 70. The air dividers 238 distribute the air flowing along the door air cooling path 72 throughout the outlet channel 228. The distribution of the air flowing through the outlet channel 228 may provide more even cooling of the door 42 and reduce high temperature spots on the outer panel 68.

With reference to FIGS. 1-14, the appliance 10 with the ventilation system 100 includes multiple airflow paths for cooling various aspects and areas of the appliance 10. The cooling fan 36 may generate the door airflow path 38, the body airflow path 40, and the door air cooling path 72 independently or in combinations with one another. In this way, the ventilation system 100 may cool the components 90 generally at the same time as cooling the door 42.

The ventilation system 100 is generally controlled by the controller 92. A user can activate the ventilation system 100 or the appliance component 90 with a user input on the control panel 94 by selecting an appliance setting, a cooking setting, a ventilation system setting, or other settings. The control panel 94 sends an input signal corresponding to the user input to the controller 92, where the controller sends a corresponding output signal to the cooling fan 36, other components of the ventilation system 100, or to appliance components 90. The output signal to the cooling fan 36 may include a fan speed. The user input may correspond to a preset program or process stored on the memory of the controller 92. The controller 92 may access the memory and send output signals to the ventilation system 100 corresponding to the program. For example, the user input may correspond to a cooking cycle where the controller sends an output signal to the appliance components 90 and to the ventilation system 100, allowing for regulation of temperature of the door 42 and the body 12 while the cooking cycle is active. Moreover, the ventilation system 100 may automatically activate to generate the various airflow paths when the cooling cycle is in process and/or for a predefined period after the cooling cycle ends.

One or more temperature sensors may be disposed in the appliance 10, including in the door 42 and/or the body 12. The temperature sensors may send an input signal to the controller 92 related to a sensed temperature. The controller 92 may compare the sensed temperature to a predefined temperature threshold and may send an output signal to activate the cooling fan 36 or adjust the fan speed based on the comparison. The controller 92 may use the temperature sensors during operation of a preset program or process, allowing the controller 92 to update operation of the ventilation system 100 from the input of the temperature sensors.

Use of the present device may provide a variety of advantages. For example, the door 42 may omit additional panels between the inner panel 62 and the outer panel 68 as the door air cooling path 72 generates a cooling effect on the door 42. Moreover, the door air cooling path 72 cools the outer panel 68 to maintain a set or reduced temperature without the inclusion of additional barriers or with use of fewer barriers between the inner panel 62 and the outer panel 68. Further, the lower number of barrier or panels reduces the amount of components and materials utilized to produce the door 42, maximizing efficiency of the manufacturing process. Also, the door air cooling path 72 may reduce or eliminate the number of protective coatings and coating layers utilized on the inner panel 62, the outer panel 68, and any additional door panels. Additionally, the door airflow path 38 and the body airflow path 40 allow for cooling of multiple components within the appliance 10, including the door 42 and the appliance components 90. Further, the distance air flowing along the door airflow path 38 travels through the body 12 is generally short and does not flow past the appliance components 90, resulting in cooler air flowing through the door 42. Moreover, the body airflow path 40 also provides for multiple airflow branches 280, 282 to improve cooling of the electronics cavity 34 and the cooking cavity 32. Additional benefits and advantages may be realized and/or achieved.

The device disclosed herein is further summarized in the following paragraphs and is further characterized by combinations of any and all of the various aspects described herein.

According to an aspect of the present disclosure, a countertop cooking appliance includes a body having a plurality of panels including a front panel defining a door outlet, a bottom panel defining an inlet, a top panel defining a body outlet, and a side panel. An internal housing is disposed in the body and defining a cooking cavity, where an electronics cavity is defined between the internal housing and the body. A cooling fan is disposed in the electronics cavity proximate to the inlet where the cooling fan is configured to direct air along a door airflow path from the inlet through the door outlet and along a body airflow path from the inlet and through the body outlet. A door is operably coupled to the body where the door is operable between a closed position and an opened position. The door includes a frame defining a first frame outlet on an upper portion of a first frame edge and a second frame outlet on an upper portion of a second frame edge. An inner panel is coupled to the frame, where the inner panel defines a door inlet on a lower portion thereof. An outer panel is coupled to the frame, where the frame, the outer panel, and the inner panel defines a channel through which air flows forming a door air cooling path for directing the air from the door inlet to the first and second frame outlets. The door inlet is in fluid communication with the door outlet when the door is in the closed position.

According to another aspect, a body airflow path includes a first airflow branch where air from an inlet, between a side panel and a side wall of an internal housing, between a top panel and a top wall of the internal housing, and to a body outlet. The body airflow path includes a second airflow branch where the air is configured to flow from the inlet, between the side panel and the side wall, through a cooking cavity, and to the body outlet.

According to yet another aspect, microwave electronics are disposed within an electronics cavity, where air directed along a body airflow path is configured to flow proximate to the microwave electronics disposed in the electronics cavity.

According to another aspect, a door outlet includes a plurality of outlet apertures defined along a width of the body.

According to yet another aspect, a door outlet is defined below a cooking cavity.

According to another aspect, an inner panel includes a glass panel disposed in a central opening of the inner panel.

According to yet another aspect, a frame has an upper portion and a lower portion defined by a crossmember, where a channel has an inlet channel in the lower portion and an outlet channel in the upper portion.

According to another aspect, a door includes an internal panel disposed between an inner panel and an outer panel, where air being directed along a door air cooling path is configured to flow between the internal panel and the outer panel.

According to another aspect of the present disclosure, a cooking appliance includes a body defining an internal cavity where the body has a front panel defining a door outlet. A cooking fan is disposed within the internal cavity. A door is operably coupled to the body. The door includes a frame defining a first outlet on an upper portion of a first frame edge and a second outlet on an upper portion of a second frame edge. An inner panel is coupled to the frame, where the inner panel defines a door inlet on a lower portion thereof to receive air directed through the door outlet by the cooling fan. An outer panel is coupled to the frame, where the frame, the outer panel, and the inner panel define a channel through which the air is configured to flow to define a door air cooling path from the door inlet and to the first and second outlets.

According to another aspect, a door has a first position and a second position, where a door inlet is disposed proximate to and in fluid communication with a door outlet of a body when the door is in a first position. The door inlet is spaced from the door outlet of the body when the door is in a second position.

According to yet another aspect, an internal housing is disposed in a body, the internal housing having a bottom wall, a first side wall, a second side wall, a back wall, and a top wall defining a cooking cavity, where a cooling fan is disposed between the internal housing and the body.

According to another aspect, a bottom panel of a body defines a body inlet, and a top panel of the body defines a body outlet. A cooling fan is configured to direct air within an internal cavity along a body airflow path from the body inlet to the body outlet and along a door airflow path from the body inlet to a door.

According to yet another aspect, an internal housing disposed in a body and defines a cooking cavity. A body airflow path has a first branch defined from a body inlet, in an internal cavity proximate to a first side panel of the body, in the internal cavity proximate a top panel, and to a body outlet. The body airflow path has a second branch defined from the body inlet, in the internal cavity proximate to the first side panel, through the cooking cavity, and to the body outlet.

According to another aspect, a door has a viewport defined by at least an outer panel and an inner panel.

According to yet another aspect, a door further includes an internal panel disposed between an outer panel and an inner panel, wherein air being directed along a door air cooling path is configured to flow between the internal panel and the outer panel.

According to another aspect of the present disclosure, an appliance door includes a frame defining a first air outlet and a second air outlet on opposing side edges of the frame. A first panel is coupled to the frame and configured to abut an appliance body when said appliance door is in a closed position. A lower portion of the first panel defines an air inlet for receiving air. A second panel is coupled to the frame, where the frame, the first panel, and the second panel define a channel through which the air is configured to flow to define a door air cooling path from the air inlet to the first and second air outlets.

According to yet another aspect, a viewport is defined by at least a first panel and a second panel, where the viewport is located above an air inlet when in a closed position.

According to another aspect, an air inlet includes a plurality of inlet apertures defined along a width of an appliance door.

According to yet another aspect, a frame includes a pair of air guides to direct air along a door air cooling path and to a first and a second air outlets.

According to another aspect, a frame includes a crossmember defining an upper portion of the frame and a lower portion of the frame, where a channel has an inlet channel in the lower portion and an outlet channel in the upper portion. A pair of air dividers are coupled to the crossmember, where the pair of air dividers are configured to divide the air flowing along the door air cooling path flowing from the inlet channel and the outlet channel into a plurality of airflow paths.

It will be understood by one having ordinary skill in the art that construction of the described disclosure and other components is not limited to any specific material. Other exemplary embodiments of the disclosure disclosed herein may be formed from a wide variety of materials, unless described otherwise herein.

For purposes of this disclosure, the term “coupled” (in all of its forms, couple, coupling, coupled, etc.) generally means the joining of two components (electrical or mechanical) directly or indirectly to one another. Such joining may be stationary in nature or movable in nature. Such joining may be achieved with the two components (electrical or mechanical) and any additional intermediate members being integrally formed as a single unitary body with one another or with the two components. Such joining may be permanent in nature or may be removable or releasable in nature unless otherwise stated.

It is also important to note that the construction and arrangement of the elements of the disclosure as shown in the exemplary embodiments is illustrative only. Although only a few embodiments of the present innovations have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements shown as multiple parts may be integrally formed, the operation of the interfaces may be reversed or otherwise varied, the length or width of the structures and/or members or connector or other elements of the system may be varied, the nature or number of adjustment positions provided between the elements may be varied. It should be noted that the elements and/or assemblies of the system may be constructed from any of a wide variety of materials that provide sufficient strength or durability, in any of a wide variety of colors, textures, and combinations. Accordingly, all such modifications are intended to be included within the scope of the present innovations. Other substitutions, modifications, changes, and omissions may be made in the design, operating conditions, and arrangement of the desired and other exemplary embodiments without departing from the spirit of the present innovations.

It will be understood that any described processes or steps within described processes may be combined with other disclosed processes or steps to form structures within the scope of the present disclosure. The exemplary structures and processes disclosed herein are for illustrative purposes and are not to be construed as limiting.

1-20. (canceled)

21. A countertop cooking appliance, comprising:
a body having a plurality of panels including a front panel defining a door outlet, a bottom panel defining an inlet, a top panel defining a body outlet, and a side panel;
an internal housing disposed in the body and defining a cooking cavity, wherein an electronics cavity is defined between the internal housing and the body;
a cooling fan disposed in the electronics cavity proximate to the inlet, wherein the cooling fan is configured to direct air along a door airflow path from the inlet and through the door outlet and along a body airflow path from the inlet and through the body outlet; and
a door operably coupled to the body, wherein the door is operable between a closed position and an opened position, the door including:
a frame defining a first frame outlet on an upper portion of a first side frame wall and a second frame outlet on an upper portion of a second side frame wall;
an inner panel coupled to the frame, wherein the inner panel defines a door inlet on a lower portion thereof; and
an outer panel coupled to the frame, wherein the frame, the outer panel, and the inner panel define a channel through which air flows forming a door air cooling path for directing the air from the door inlet to the first and second frame outlets, and wherein the door inlet is in fluid communication with the door outlet when the door is in the closed position.

22. The countertop cooking appliance of claim 21, wherein the body airflow path includes a first airflow branch where the air is configured to flow from the inlet, between the side panel and a side wall of the internal housing, between the top panel and a top wall of the internal housing, and to the body outlet, and wherein the body airflow path includes a second airflow branch where the air is configured to flow from the inlet, between the side panel and the side wall, through the cooking cavity, and to the body outlet.

23. The countertop cooking appliance of claim 21, further comprising:
microwave electronics disposed within the electronics cavity, wherein the air directed along the body airflow path is configured to flow proximate to the microwave electronics disposed in the electronics cavity.

24. The countertop cooking appliance of claim 21, wherein the door outlet includes a plurality of outlet apertures defined along a width of the body.

25. The countertop cooking appliance of claim 21, wherein the door outlet is defined below the cooking cavity.

26. The countertop cooking appliance of claim 21, wherein the inner panel includes a glass panel disposed in a central opening of the inner panel.

27. The countertop cooking appliance of claim 21, wherein the frame has the upper portion and a lower portion defined by a crossmember, and wherein the channel has an inlet channel in the lower portion and an outlet channel in the upper portion.

28. The countertop cooking appliance of claim 21, wherein the door includes an internal panel disposed between the inner panel and the outer panel, wherein the air being directed along the door air cooling path is configured to flow between the internal panel and the outer panel.

29. A cooking appliance, comprising:
a body defining an internal cavity, wherein the body has a front panel defining a door outlet;
a cooling fan disposed within the internal cavity; and
a door operably coupled to the body, the door including:
a frame defining a first outlet on an upper portion of a first side frame wall and a second outlet on an upper portion of a second side frame wall;
an inner panel coupled to the frame, wherein the inner panel defines a door inlet on a lower portion thereof to receive air directed through the door outlet by the cooling fan; and
an outer panel coupled to the frame, wherein the frame, the outer panel, and the inner panel define a channel through which the air is configured to flow to define a door air cooling path from the door inlet and to the first and second outlets.

30. The cooking appliance of claim 29, wherein the door has a first position and a second position, and wherein the door inlet is disposed proximate to and in fluid communication with the door outlet of the body when the door is in the first position, and wherein the door inlet is spaced from the door outlet of the body when the door is in the second position.

31. The cooking appliance of claim 29, further comprising:
an internal housing disposed in the body, the internal housing having a bottom wall, a first side wall, a second side wall, a back wall, and a top wall defining a cooking cavity, wherein the cooling fan is disposed between the internal housing and the body.

32. The cooking appliance of claim 29, wherein a bottom panel of the body defines a body inlet and a top panel of the body defines a body outlet, wherein the cooling fan is configured to direct air within the internal cavity along a body airflow path from the body inlet to the body outlet and along a door airflow path from the body inlet to the door outlet.

33. The cooking appliance of claim 32, further comprising:
an internal housing disposed in the body and defines a cooking cavity, and wherein the body airflow path has a first airflow branch defined from the body inlet, in the internal cavity proximate to a first side panel of the body, in the internal cavity proximate the top panel, and to the body outlet, and further wherein the body airflow path has a second branch defined from the body inlet, in the internal cavity proximate to the first side panel, through the cooking cavity, and to the body outlet.

34. The cooking appliance of claim 29, wherein the door has a viewport defined by at least the outer panel and the inner panel.

35. The cooking appliance of claim 29, wherein the door further includes:
an internal panel disposed between the outer panel and the inner panel, wherein the air being directed along the door air cooling path is configured to flow between the internal panel and the outer panel.

36. An appliance door, comprising:
a frame defining a first air outlet and a second air outlet on opposing side edges of the frame;
a first panel coupled to the frame and configured to abut an appliance body when said appliance door is in a closed position, wherein a lower portion of the first panel defines an air inlet for receiving air; and
a second panel coupled to the frame, wherein the frame, the first panel, and the second panel define a channel through which the air is configured to flow to define a door air cooling path from the air inlet to the first and second air outlets.

37. The appliance door of claim 36, further comprising:
a viewport defined by at least the first panel and the second panel, wherein the viewport is located above the air inlet when in the closed position.

38. The appliance door of claim 36, wherein the air inlet includes a plurality of inlet apertures defined along a width of said appliance door.

39. The appliance door of claim 36, wherein the frame includes:
a pair of air guides configured to direct the air along the door air cooling path and to the first and second air outlets.

40. The appliance door of claim 36, wherein the frame includes:
a crossmember defining an upper portion of the frame and a lower portion of the frame, wherein the channel has an inlet channel in the lower portion and an outlet channel in the upper portion; and
a pair of air dividers coupled to the crossmember, where the pair of air dividers are configured to divide the air flowing along the door air cooling path into a plurality of airflow paths.
